(19) United States
(12) Patent Application Publication
(10) Pub. No.: US 2002/0114409 A1
(43) Pub. Date: Aug. 22, 2002

(54) Serial data communication apparatus and detection method for communication error

(76) Inventor: Yasunori Shingaki, Tokyo (JP)

Correspondence Address: Platon N. Mandros, BURNS, DOANE, SWECKER & MATHIS, L.L.P., P.O. BOX 1404, Alexandria, VA, 22313-1404, US

(21) Appl. No.: 09/978,054

(22) Filed: Oct. 17, 2001

(30) Foreign Application Priority Data
Feb. 22, 2001 (JP) 2001-47210

(51) Int. Cl. H04L 27/06; H04L 25/38

(52) U.S. Cl. 375/340; 375/369

(57) ABSTRACT

A communication apparatus according to the present invention detects the trailing edge of the received data and, with the detection of the trailing edge the apparatus, acknowledges the reception of the start bit in the received data. The bit level of the start bit is monitored to examine whether or not the bit level is at a predetermined bit level. If any change is detected, a signal indicating occurrence of a start-bit-detection error is output to the outside.

### BACKGROUND OF THE INVENTION

1. Field of the Invention

The present invention relates to a serial data communication apparatus which operates as a UART (Universal Asynchronous Receiver and Transmitter) performing serial data transmission according to the asynchronous method and, more particularly, to a serial data communication apparatus and a communication error detection method which gives a notification of a failure to detect a start bit.

2. Description of the Related Art

FIG. 5 schematically shows the configuration of a conventional serial data communication apparatus which is operated as a UART. In the figure, reference numeral 10 denotes a conventional serial data communication apparatus, 11 denotes a T×D terminal which outputs the transmission data from a transmitting block 13, 12 denotes an R×D terminal which receives serial data from an external circuit, 13 denotes a transmitting block which generates serial data to be transmitted as shown in FIG. 6 and performs data transmission according to the asynchronous method, and 14 denotes a receiving block which receives serial data through the R×D terminal 12.

FIG. 6 shows an illustrative view for explaining the start-bit-detecting operation of the serial data by the serial data communication apparatus described in FIG. 5. In the figure, a symbol SB denotes a start bit of serial data, D6 through D0 denote the data to be sequentially transmitted using respective bits. SP denotes a stop bit of the serial data. As shown in FIG. 6, the following assumptions are assumed with respect to the serial data handled by the serial data communication apparatus in order to simplify the explanation. The length of the data is 7 bits (D6 through D0), the stop bit is formed with 1 bit, and the parity check bit is zero.

Next, the operation will be explained.

For example, when the serial communication apparatus 10 in an idle state (a state where the apparatus is not operating; during this period of time the input at the R×D terminal is at H level) inputs the serial data generated by the transmitting block 13 in another serial data communication apparatus, the receiving block 14 in the serial data communication apparatus 10 detects the trailing edge of the received serial data at the R×D terminal 12. At this time, the receiving block 14 acknowledges the detected trailing edge as the trailing edge of the start bit SB which shows the start of communication so that the receiving block 14 starts an internal receiving operation.

After that, the receiving block 14 checks once more the input level of the R×D terminal 12 at the intermediate point of time constituting the start bit SB (a point shown by an arrow mark in FIG. 6). When the input at the R×D terminal 12 is at L level, the receiving block 14 confirms that the previously detected trailing edge is the edge of the start bit SB, and continues the receiving operation of the above-mentioned serial data.

When the input at the R×D terminal 12 is at H level at the intermediate point of the start bit SB, the receiving block 14 judges that the previously detected trailing edge is caused by noise and stops the receiving operation for receiving the serial data. As described above, a judgement as to whether the detected signal is a noise or not is made at 2 points of the start bit SB of the serial data; therefore, erroneous performance of the receiving operation can be prevented.

A conventional serial-data-communication apparatus constituted as described above has no means to recognize a failure in the detection of the start bit of the received serial data. Therefore in some cases, considerable time is required to discover and repair malfunctions in start bit detection.

The above mentioned problem will be explained concretely.

FIG. 7 shows an illustrative view for explaining the receiving operation in a case where the noise at H level occurs at the R×D terminal at a point of time for checking the start bit. At first, similar to the above case, the receiving block 14 detects the trailing edge of the received serial data at the R×D terminal 12. In this case, it is assumed that the receiving block 14 detected the trailing edge of the serial data caused by the start bit SB which shows the start of communication.

After that, the receiving block 14 checks once more the input level of the R×D terminal at the intermediate point of the start bit SB. At this time, as shown in FIG. 7, if the noise at H level appears at the R×D terminal 12 at the above-mentioned intermediate point, the receiving block 14 judges that the detected trailing edge is caused by the noise and stops the receiving operation for receiving the serial data, regardless of the correct detection of the trailing edge of the serial data caused by the start bit SB.

Following the above operation, the receiving block 14 detects the trailing edge of the noise. By this detection, the receiving block 14 takes the trailing edge of the noise for that generated by the new start-bit SB and starts the internal receiving operation. When the data D6 input to the R×D terminal 12 subsequent to this detection is at L level, the L level is determined to be maintained at the second start-bit-check point, which is subsequent to the time point when the receiving block 14 detected the trailing edge caused by the noise. In other words, the error in the start-bit-check is overlooked so that the internal receiving operation for the serial data is continued by the receiving block 14.

When such a state results in the receiving block 14, the receiving block 14 continues to receive the serial data with bit-shifted errors through the R×D terminal 12. For example, when the specification of the serial-data-communication apparatus 10 defines the value of a bit as the level occurring at the intermediate point of time constituting the bit, an erroneous reception occurs such that, the level occurring at the intermediate time point between data D6 and data D5 is received as the bit value of the data D6, when actually the data D6 should start to be received.

Even when the data D6 which is input to the R×D terminal 12 subsequent to the detection of the trailing edge caused by the above-mentioned noise is at H level, it can be easily imagined that if any of the data D5 through D0 is at L level, the serial data containing bit-shift errors is received.

When the transmitted data and the received data which are different from each other as a result of an error are subject to comparison, the difference cannot be properly detected by the error detection function of UART, including an frame error check whereby an error is identified by detecting an L level at the time point of the stop bit SP.

### SUMMARY OF THE INVENTION

Accordingly, a general object of the present invention is to provide a serial data communication apparatus and a communication error detection method in which the aforementioned problem is eliminated.

Another and more specific object is to provide a serial data communication apparatus and a communication error detection method in which a failure to detect a start bit in serial data communication is promptly recognized by providing a means to give a notification of an occurrence of an error in detecting a start bit.

The aforementioned objects can be achieved by a serial-data-communication apparatus for transmitting and receiving serial data composed of a plurality of bits including a start bit at a head, comprising: edge-detection means for detecting a trailing edge of received data; start-bit-level-inspection means for recognizing the reception of the start bit of the received data with the detection of the trailing edge provided by the edge-detection means, and monitoring a bit level of the start bit to examine whether the start bit maintains a predetermined bit level; and start-bit-detection-error-notification means which outputs a signal to an external circuit, the signal indicating occurrence of an error in detecting the start bit, when any change in the bit level of the start bit is detected by the start-bit-level-inspection means.

The start-bit-detection-error-notification means may output a signal, indicating occurrence of a start bit detection error, to a CPU, controlling the transmission and reception of the serial data, as an interrupt request signal.

The aforementioned objects can also be achieved by a method of detecting a communication error in transmission and reception of serial data composed of a plurality of bits including a start bit at a head, comprising the steps of: detecting a trailing edge of received data; recognizing the reception of the start bit of the received data with the detection of the trailing edge, monitoring a bit level of the start bit to examine whether the start bit maintains a predetermined bit level; and outputting a signal to an external circuit, the signal indicating occurrence of an error in detecting the start bit, when any change in the bit level of the start bit is detected.

The signal indicating occurrence of the error in detecting the start bit may be output to a CPU, controlling the transmission and reception of the serial data, as an interrupt request signal.

### BRIEF DESCRIPTION OF THE DRAWINGS

Other objects and further features of the present invention will be apparent from the following detailed description when read in conjunction with the accompanying drawings, in which:

FIG. 1 shows a block diagram showing the configuration of a serial data communication apparatus explained in a first embodiment according to the present invention;

FIG. 2 shows the concrete configuration of the start-bit-level-check circuit shown in FIG. 1;

FIG. 3 shows a timing chart showing the changes of respective signals when the serial-data-communication apparatus shown in the first embodiment makes a normal start-bit-level check;

FIG. 4 shows a timing chart showing the changes of respective signals when the serial-data-communication apparatus shown in the first embodiment failed in a start-bit-level check;

FIG. 5 shows the outline of the configuration of a conventional serial-data-communication apparatus which operates as a UART;

FIG. 6 shows an illustrative drawing for explaining the start-bit-detection operation by the serial data communication apparatus shown in FIG. 5; and

FIG. 7 shows an illustrative drawing for explaining the receiving operation in the case where noise at H level appeared at the R×D terminal at the timing of the start-bit-check point.

### DESCRIPTION OF THE PREFERRED EMBODIMENTS

In the following, embodiments according to the present invention will be explained referring to the drawings.

First Embodiment

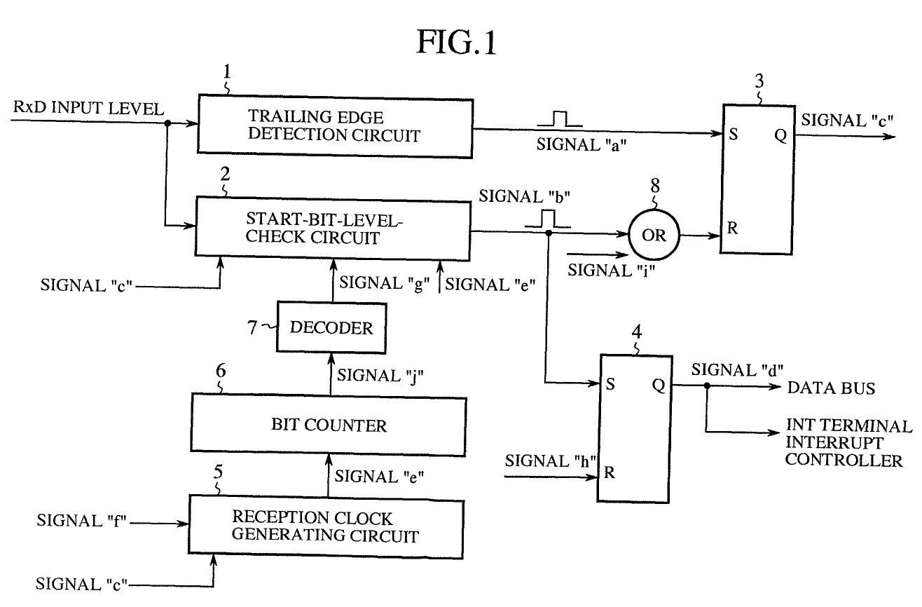

FIG. 1 shows a block diagram showing the configuration of a serial data communication apparatus according to a first embodiment of the present invention. In the figure, reference numeral 1 denotes a trailing edge detection circuit (edge detection means) which detects a trailing edge of data input to the R×D terminal. When the trailing edge detection circuit detects a trailing edge, it generates a signal “a” at H level. Reference numeral 2 denotes a start-bit-level-check circuit (start-bit-level-inspection means) for latching data input to R×D terminal in synchronization with the leading edge of a signal “e” sent from a reception-clock-pulse-generating circuit 5. The latched signal and a signal “g” from a decoder 7 are ANDed, and when the start-bit-level check circuit 2 fails to detect the start bit, it outputs a pulse signal “b” at H level. Reference numeral 3 denotes an RS flip-flop (hereinafter referred to as FF3) which is set by a signal “a” sent by the trailing edge detection circuit 1 and is reset by a signal “b” from the start-bit-level-check circuit 2 ORed with a signal “i” from a 1 frame-data-detection circuit (not shown). The RS flip-flop generates a signal “c” which shows authorization/non-authorization of receiving operation. Reference numeral 4 denotes an RS flip-flop circuit (start-bit-detection-error-notification means) (hereinafter referred to as FF4) which is set by a signal “b” sent from the start-bit-level-check circuit 2 and is reset by a signal “h” from CPU (not shown). The RS flip-flop circuit 4 generates a signal “d” which shows the presence or absence of the start-bit-detection error.

Reference numeral 5 denotes a reception-clock-pulse-generation circuit which generates, when the signal “c” from the FF3 goes to H level, the signal “e”, a clock signal having a period equal to the duration of a bit constituting the serial data, in accordance with the baud rate set using a signal “f”, a fundamental clock signal input from a clock pulse oscillator (not shown). During the period while the signal “c” is at L level, the reception-clock-pulse generator 5 outputs the signal “e” at H level, and when the signal “c” goes to H level, it outputs the signal “e” as a clock signal which starts from L level. 6 denotes a bit counter (a start-bit-level-inspection means), in which the number of bits to be received in a frame of the received data is set and which counts down at every bit in the received data. The bit counter 6 utilizes the trailing edge of the signal “e” from the reception-clock-pulse-generator 5 as the count-down-clock pulse. In the bit counter 6, the number of bits to be received is reloaded every time the trailing edge of the signal “c” is detected. Reference numeral 7 denotes a decoder (a start-bit-level-inspection means) and when a bit-count value input from the bit counter 6 coincides with the number of bits to be received in a frame, it generates a signal “g” at H level and outputs the signal “g” to the start-bit-level-check circuit 2. Reference numeral 8 denotes an OR circuit which calculates a logical OR of the signal “b” from the start-bit-level-check circuit 2 and the signal “i” from the 1-frame-data-detection circuit (not shown).

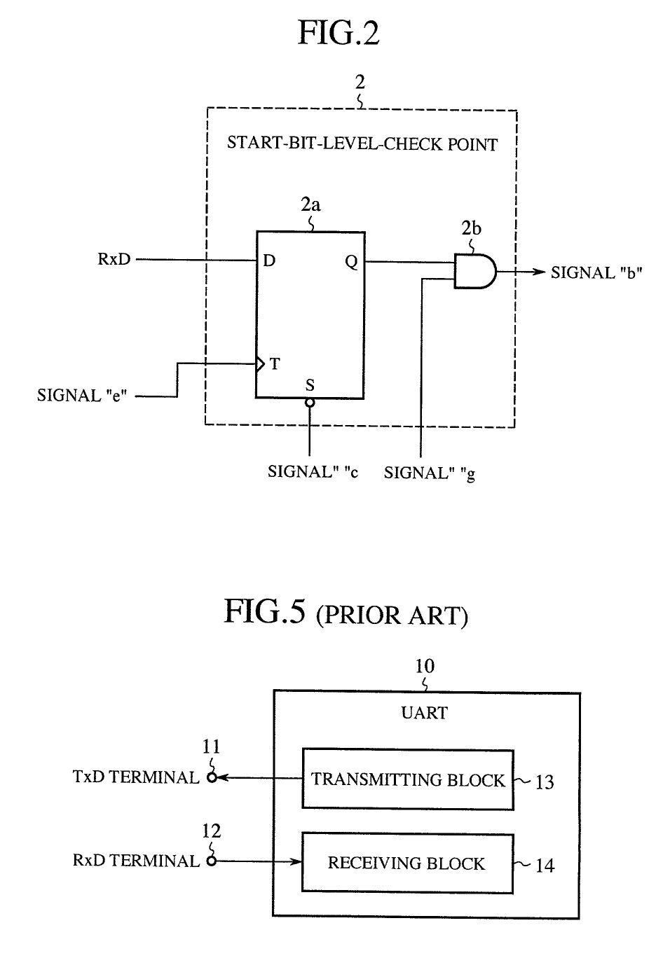

FIG. 2 shows a chart showing the concrete configuration of the start-bit-level-check circuit shown in FIG. 1. In the figure, a symbol 2a denotes a latch circuit (start-bit-level-inspection means) which latches the input data from R×D terminal in synchronization with the leading edge of the signal “e” from the reception-clock-pulse-generation circuit 5. The latch circuit 2a is composed of a D flip-flop circuit. When a signal at H level is fed to the S input (i.e., while the signal “c” is at L level showing that the reception of data is not authorized), the latch circuit is initialized to H level. In the figure, 2b denotes an AND circuit (start-bit-level-inspection means) which calculates a logical AND of a signal latched by the latch circuit 2 and the signal “g” from the decoder 7. The same components as those in FIG. 1 are denoted by the same reference numerals and therefore additional description will be omitted.

Next the explanation on the operations will be given.

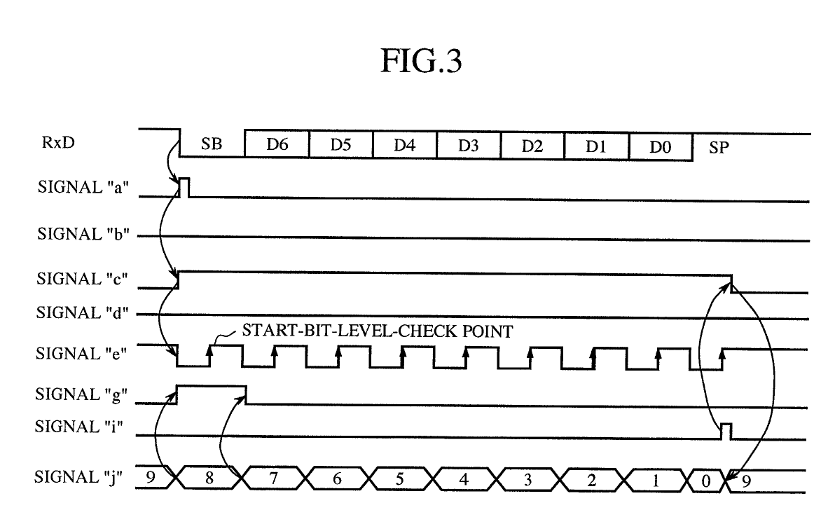

FIG. 3 shows a timing chart showing a change of respective signals when a serial-data-communication apparatus according to the first embodiment performs a normal start-bit-level check. In FIG. 3, SB denotes a start bit of serial data, D6 through D0 denote data which are transmitted sequentially bit-by-bit subsequent to the start bit SB, and SP denotes a stop bit of the serial data. In order to simplify the explanation, it is assumed that the data length is 7 bits (D6 through D0), the stop bit is composed of 1 bit, and the parity check bit is zero.

When the serial data is input from an external circuit to the R×D terminal, the trailing-edge-detection circuit 1 detects the trailing edge of the above-mentioned serial data so as to generate a pulse signal “a” at H level. The signal “a” is fed to the S input of the FF3. In the idle period, a signal at L level is input from the OR circuit 8 to the R input of the FF3. Thus, when the H-level signal “a” is input to the S input of the FF3, RS latch is set in the FF# so that the signal “c” at H level is output from the Q output, indicating that receiving operation is authorized. This signal “c” is input to the start-bit-level-check circuit 2 and to the reception-clock-pulse-generating circuit 5.

Triggered by the input signal c at H level, the reception-clock-pulse-generating circuit 5 generates the clock-pulse signal “e” having a period equal to the duration of 1 bit of the serial data, by frequency-dividing the signal “f” which is a fundamental clock signal input from an external-clock-pulse-oscillator circuit (not shown). This signal “e” is input to the start-bit-level-check circuit 2 and to the bit-countdown circuit 6.

When the bit-counter circuit 6 detects a trailing edge of a clock signal which constitutes the signal “e”, it down-counts from the set value (in the example shown in the figure, the set value is 9) indicating the number of information bits per frame (i.e., the number of bits including the start bit SB and the stop bit SP) constituting a frame of the serial data. The bit count value is output to the decoder 7 as a signal “j”.

The decoder 7 decodes the count (signal “j”) from the bit counter 6 so as to bring the signal “g” to H level only during a period of time in which the bit count value is 8 (i.e. while the bit count matches the number of bits to be received subsequently in a frame). This period of time indicates the position of the start bit. The decoder 7 outputs the signal “g” to the start-bit-level-check-circuit 2.

When the trailing edge of the clock signal which constitutes the signal “e” is detected by the start-bit-level-check circuit 2, the start-bit-level-check circuit 2 latches the serial data input from the R×D terminal and calculates a logical AND of the latched value and the signal “g” from the decoder 7.

The start-bit-level-check circuit 2 may have a circuit configuration as shown in FIG. 2. The latch circuit 2a sequentially receives the serial data from the R×D input at the D input in synchronization with a first leading edge of the signal “e”, the reception clock signal provided from the reception-clock-pulse-generating circuit 5 via the T input. For example, during the period in which the start bit input from an external circuit to the R×D terminal is being received (the period in which bit count value (signal “j”)=8, indicating the position of the start bit), the serial data at L level is fed from the R×D terminal to the D input.

The signal “c” at H level from the FF3 is inverted at the S input, goes to L level and is fed to the latch circuit 2a. Thus, the latch circuit 2a is not set, and the serial data are transparently output from the Q output. The serial data output from the latch circuit 2a and the signal “g” are input to the AND circuit 2b. In the AND circuit 2b, the logical AND is calculated of the serial data from the latch circuit 2a and the signal “g”, and the result of operation is output as the signal “b”.

At this time, if the start bit in the serial data from an external circuit is being received at the R×D terminal (the period in which bit count value (signal “j”)=8, indicating the position of the start bit), the signal “g” from the decoder 7 is at H level, so that the output from the latch circuit 2a is at L level. Therefore, the signal “b” at L level is output from the AND circuit 2b.

In contrast, during the period in which the data bit of the serial data is being input from an external circuit to the R×D terminal (the period in which bit count value (signal “j”)=7−0), the signal “g” from the decoder 7 is at L level, so that the signal “b” at L level is output from the AND circuit 2b.

The signal “b” at L level output from the start-bit-level-check circuit 2 is input to the S input of the FF4 and also to the OR circuit 8 together with the signal “i” at L level. In the OR circuit 8, a logical OR of the signal “b” and the signal “i” is calculated, and the result is output to the R input of the FF3.

The signal “i” is normally at L level, and when the number of bits for 1 frame of serial data are input via the R×D terminal, the signal “i” goes to H level. When the start bit of the serial data, received from an external circuit via the R×D terminal, is being received, both the signal “i” and the signal “b” are at L level. Thus, the OR circuit 8 outputs a signal at L level to the R input of the FF3.

The above-mentioned signal “i” is generated by the 1 frame-data-detection circuit (not shown) which detects that the serial data for 1 frame, which are input from the R×D terminal, have been received using the count value of the bit counter 6.

In the FF4, the signal “b” at L level is input to the S input and to the R input a signal “h” controlled to be at L level by the CPU (not shown) is input. Thereby, an RS set does not occur so that a signal “d”, which is maintained at an initial L level, is output from the Q output. The signal “d” is sent to the CPU via a data bus and also to an INT terminal connected to an interrupt controller which performs interrupt control.

In contrast, in the FF3, the signal “a” is returned to L level after being transformed into a pulse at H level as a result of the detection of a trailing edge of the serial data input to the R×D terminal. Thereafter the signal “a” at L level is input to the S input. The signal at L level from the OR circuit 8 is input to the R input. Thereby, the value at the Q output does not change and the signal “c” at H level is output. Therefore, the receiving operation is made to continue.

Thereafter, when the receiving operation proceeds so that 1 frame of the serial data input via the R×D terminal is received, the above-mentioned 1 frame-data detection circuit (not shown) detects the reception of the serial data 1 frame and outputs the pulse signal “i” at H level to OR circuit 8. Thus, the OR circuit 8 calculates a logical OR of the signal “b” at L level and the signal “i” at H level, and as a result of the calculation, a signal at H level is output to the R input of the FF3.

When a signal at H level is input to the R input, the FF3 is reset and outputs the signal “c” at L level, indicating that the receiving operation is not authorized, from the Q output. The signal “c” at L level is input to the start-bit-level-check circuit 2 and to the reception-clock-pulse-generator circuit 5. When the reception-clock-pulse generator circuit 5 receives the signal “c” at L level, it generates the signal “e” at H level. The signal “e” at H level is input to the start-bit-level-check circuit 2 and the bit counter 6. When the bit counter 6 receives the signal “e” at H level, it is reloaded with the number of bits (=9) to be received in 1 frame of the serial data input to the R×D terminal.

When the start-bit-level-check circuit 2 receives the signal “c” at L level, it outputs the signal “b” at L level. This is described hereafter in detail referring to FIG. 2. The latch circuit 2a sequentially latches the serial data input to the D input via the R×D terminal, in synchronization with the first leading edge of the signal “e” (the reception clock signal from the reception-clock-signal-generating circuit 5 received via the T input). And the signal “c” at L level from the FF3 is inverted at the S input, turned to a signal at H level and taken in by the latch circuit 2a. Thus, the latch circuit 2a is set and a signal at H level is output from the Q output. In contrast, the signal at H level output from the latch circuit 2a is input to the AND circuit 2b together with the signal “g” from the decoder 7. In the AND circuit 2b, a logical AND of the H level signal from the latch circuit 2b and the signal “g” is calculated, and the result is output as the signal “b”.

At this time, since data bits of the serial data input from an external circuit to the R×D terminal are being received (the period in which bit count value (signal “j”)=7−0), the signal “g” from the decoder 7 is at L level, so that the signal “b” at L level is output from the AND circuit 2b.

This completes the receiving operation for receiving 1 frame of the serial data.

When the serial data are input to the R×D terminal subsequent to the above operation, the trailing-edge-detection circuit 1 detects the trailing edge of the serial data, and simultaneously it generates the signal “a”, a pulse signal at H level. When the signal “a” is input to the S input of the FF3, the FF3 is reset and again outputs the signal “c” at H level. Thus, the receiving operation is repeated.

Next, the operation performed in a case where the apparatus failed in the start-bit-level check will be explained.

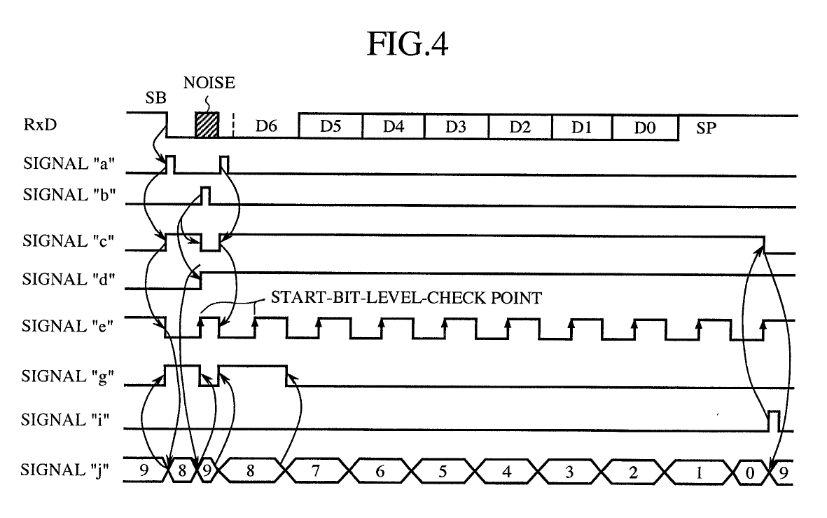

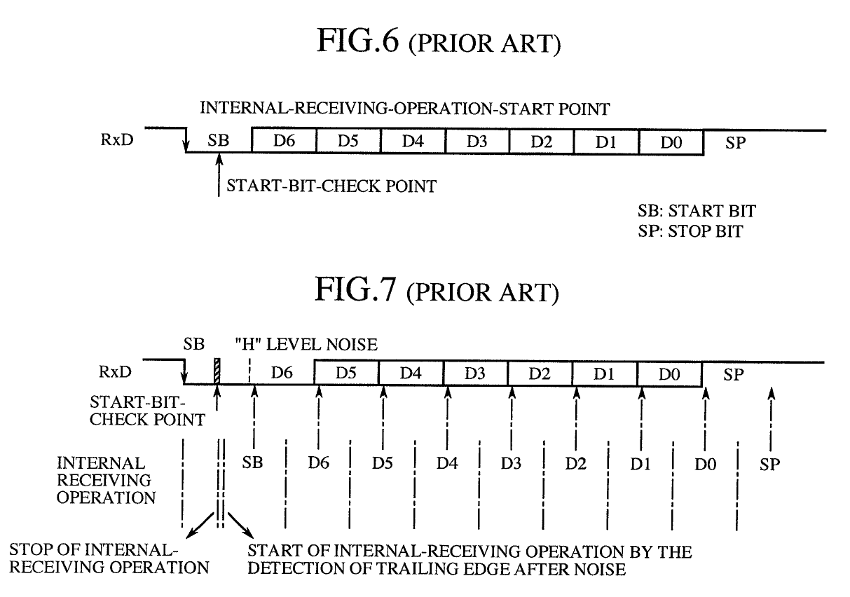

FIG. 4 shows a timing chart showing the changes of respective signals in a case where the serial data communication apparatus according to the embodiment 1 failed in the start-bit-level check; and the explanation will be given referring to FIG. 4. Elements identical to those shown in FIG. 3 are given identical symbols and duplicate explanation will be omitted.

At first, when the serial data are input to the R×D terminal from an external circuit, the trailing edge detection circuit 1 detects the trailing edge of the serial data and also generates the signal “a”, a pulse signal at H level. This signal “a” is input to the S input of the FF3. In an idle state, a signal at L level is input from the OR circuit 8 to the R input of the FF3. Thereby, when the signal “a” at H level is input to the S input, RS-latch is set in the FF3 and from the Q output the signal “c” at H level, indicating authorization of the receiving operation, is output. This signal “c” is input to the start-bit-level-check circuit 2 and to the reception-clock-pulse-generating circuit 5.

Triggered by the signal “c” at H level, the receiving-clock-pulse-generation circuit 5 generates the signal “e” by frequency-dividing the signal “f” which is the fundamental-clock-pulse signal input from the external clock-pulse-oscillator circuit (not shown). The signal “f” is a clock-pulse signal having a period equal to the duration of 1 bit of the serial data. The signal “e” is input to the start-bit-level-check circuit 2 and the bit counter 6.

When the bit counter 6 detects the trailing edge of the clock pulse signal which constitutes the signal “e”, it down-counts from the set value (in the example shown in the figure, the set value is 9) indicating the number of information bits per frame (i.e., the number of bits including the start bit SB and the stop bit SP) constituting a frame of the serial data. The bit count value is output to the decoder 7 as the signal “j”.

The decoder 7 decodes the count (signal “j”) from the bit counter 6 so as to bring the signal “g” to H level only during a period of time in which the bit count value is 8 (i.e. while the bit count matches the number of bits to be received subsequently in a frame). This period of time indicates the position of the start bit.

When the trailing edge of the clock signal which constitutes the signal “e” is detected by the start-bit-level-check circuit 2, the start-bit-level-check circuit 2 latches the serial data input from the R×D terminal and calculates a logical AND of the latched value and the signal “g” from the decoder 7.

The operation up to this point is identical to that of a normal case.

It is assumed that, during the period in which the start bit of the serial data input to the R×D terminal from an external circuit is being received (the period in which bit count value (signal “j”)=8, indicating the position of the start bit), noise at H level occurs at the R×D terminal at a point of time for checking the start-bit level (start-bit-level-check point). The start-bit-level-check circuit 2 outputs the signal “b” at H level.

This operation will be explained referring to FIG. 2. The latch circuit 2a sequentially receives the serial data from the R×D terminal at the D input, in synchronization with the first leading edge of the signal “e”, the reception clock-pulse signal input from the reception clock-pulse signal-generating circuit 5 via the T input. Normally, while the start bit of the serial data input to the R×D terminal is being received (the period in which the bit count value (signal “j”)=8), the serial data at L level is received at the D input from an external circuit via the R×D terminal. Instead, the noise is received.

The signal “c” at H level from the FF3 is inverted at the S input, brought to L level and received by the latch circuit 2a. Thus, the latch circuit 2a is not set and from the Q output the above-mentioned noise is output as it is. The noise signal at H level output from the latch circuit 2a is input to the AND circuit 2b together with the signal “g” from the decoder 7. In the AND circuit 2b, a logical AND of the above-mentioned noise at H level with the signal “g” is calculated so as to output the result as the signal “b”.

Normally, during the period in which the start bit of the serial data input via the R×D terminal from an external circuit is being received (the period in which the bit count value bit (signal “j”)=8, indicating the position of the start bit), the output of the latch circuit 2a is at L level and the signal “g” from the decoder 7 is at H level. Therefore, from the AND circuit 2b the signal “b” at L level is to be output. When the noise at H level occurs, the signal “b” at H level is output. During the period in which the data bit of the serial data input via the R×D terminal from an external circuit is being received (the period in which the value of bit count (signal “j”)=7 to 0), the signal “g” from the decoder 7 is at L level, so that the signal “b” at L level is output from the AND circuit 2b.

The signal “b”, which is brought to H level due to the noise at H level occurring on the input via the R×D terminal, is input to the S input of the FF4 and also to the OR circuit 8 together with the signal “i” at L level. In the OR circuit 8, a logical OR of the signal “b” and the signal “i” is calculated, and the result is output to the R input of the FF3.

In the case illustrated in FIG. 4, the start bit of the serial data, which is input via the R×D terminal from an external circuit, is being received, so that the signal “i” is at L level, and the OR circuit 8 outputs a signal at H level to the R input of the FF3.

In the FF4, the signal “b” at H level is input to the S input and the signal “h” controlled to be at L level by the CPU (not shown) is input to the R input. Thus, the FF4 is set and the signal “d” at H level is output from the Q output, indicating an error in detecting a start bit. This signal “d” is sent to the CPU and also sent to the INT terminal connected to an interrupt controller for performing interrupt control.

The above mentioned signal “d” is readable from the CPU via a data bus, so that the CPU is informed of the error when the bit affected by the noise is communicated.

Since the signal at H level is input from the OR circuit 8 to the R input, the FF3 is reset and the signal “c” at L level, indicating that the receiving operation is not authorized, is output from the Q output. This signal “c” at L level is input to the start-bit-level-check circuit 2 and the reception-clock-pulse-generating circuit 5. When the reception-clock-pulse-generating 5 receives the signal “c” at L level, it generates the signal “e” at H level. The signal “e” is input to the start-bit-level-check circuit 2 and the bit counter 6.

When the bit counter 6 receives the signal “e” at H level, the predetermined value 9, indicating the number of bits received in 1 frame of the serial data input via the R×D terminal, is set again. In the example shown in FIG. 4, as a result of the noise at H level occurring while the bit-count value (signal “j”) is 8, the bit count value (signal “j”) is reset to 9 in the middle of the reception of the data (start bit).

After that, when the noise at H level goes away while the start bit of the serial data input via the R×D terminal, the trailing edge detection circuit 1 detects the trailing edge of the noise and generates the signal “a” at H level. The signal “a” at H level is input to the S input of the FF3.

The start-bit returning to L level with the disappearance of the noise is input to the start-bit-level-check circuit 2. Thus, the signal “b” at L level is output from the start-bit-level-check circuit 2.

Referring to FIG. 2, the latch circuit 2a sequentially receives the serial data input via the R×D terminal at the D input, in synchronization with the first leading edge of the signal “e” sent from the reception-clock-pulse-generating circuit 5.

The signal “c” from the FF3 brought to L level due to the noise at H level is inverted at the S input of the latch circuit 2a. Thus, the latch circuit 2a is set and a signal at H level is output from the Q output. The signal at H level output from the latch circuit 2a is input to the AND circuit 2b together with the signal “g” from the decoder 7. In the AND circuit 2b, a logical AND of the H level signal from the latch circuit 2a and the signal “g” is calculated and the result is output as the signal “b”. Since the bit-count value (signal “j”) is reset to 9, the signal “g” from the decoder 7 is at L level, and the L level signal “b” is output from the AND circuit 2b.

The L level signal “b” output from the start-bit-level-check circuit 2 is input to the S input of the FF4 and also input to the OR circuit 8 together with the L level signal “i”. In the OR circuit 8, a logical OR of the signal “b” and the signal “i” is calculated, and the result is output to the R input of the FF3.

The signal “i” is normally at L level and, only when the apparatus received the bits for 1 frame of the serial data via the R×D terminal, the signal “i” is brought to H level. Since both the signal “i” and the signal “b” are at L level, the OR circuit 8 outputs a signal at L level to the R input of the FF3.

In the FF4, the signal “b” at L level in input to the S input and the signal “h” which is controlled to be at L level by the CPU (not shown) is input to the R input, so that the apparatus is not RS-set and the signal “d” which is brought to H level due to the above-mentioned noise at H level continues to be output from the Q output. The signal “d” is sent out to the CPU and also to the INT terminal connected to the interrupt controller.

In the FF3, the signal “a” at H level from the trailing edge detection circuit 1, having detected the trailing edge of the noise at H level, is input to the S input, and to the R input a signal at L level from the OR circuit 8 is input. Thus, the FF3 is set and outputs the signal “c” at H level. The signal “c” at H level indicates authorization of the receiving operation, so that the receiving operation is continued.

If the data bit D6 received while the bit count value is 8 is at L level, the normal receiving operation is performed. If the data bit D6 is at H level, the data at H level is input to the D input of the latch circuit 2a which constitutes the start-bit-level-check circuit 2. The signal “g” at H level is input from the decoder 7, so that the AND circuit 2b outputs the signal “b” at H level. Therefore, it is recognized that the start-bit-detection error occurred again. The signal “d” output from the FF4 is maintained at H level.

When the start-bit-detection error as described above occurs, the receiving operation shifted by 1 bit proceeds, as shown in FIG. 4. However, since the signal “d” which shows a start-bit-detection error can be read by the CPU via a data bus, it is immediately known that there was an error in the detection of start bit after the communication shifted by 1 bit is completed.

In the case of a one-chip microcomputer, it is possible to know the occurrence of an error in the start bit detection, using the signal “d” as an interrupt signal. Further, in the case of a UART alone, it is possible for the CPU to know that there was an error in the start bit detection, by outputting the signal “d” from the INT terminal notifying an interrupt request.

The CPU, which is notified of the error in the start bit detection by the signal “d”, brings the signal “h”, output to the R input of the FF4, to H level by executing an instruction to reset the value of the signal “d”, the flag showing the occurrence of a start bit detection error. Thereby, the FF4 is reset and the signal “d” is initialized to L level.

As described above, according to the first embodiment, the trailing edge of the received data is detected and, with the detection of the trailing edge, the reception of the start bit of the received data is recognized. The level of the start bit is monitored so as to examine whether it is at a predetermined level. If any change in the bit level is detected, the signal “d” at H level, indicating occurrence of the stat-bit-detection error, is output to an external circuit, so that the occurrence of the start bit detection error can be immediately recognized. Therefore, the trouble relating to the occurrence of the start bit detection error is immediately discovered and the time for recovery can be reduced.

According to the first embodiment, the signal “d” at H level, indicating occurrence of the start-bit-detection error, is output to the CPU as an interrupt signal, so that by making the occurrence of the start-bit-detection error a trigger, it is made possible to let the CPU execute an interrupt process to repair the trouble concerning the start-bit-detection error. Therefore, the period of time needed for repairing the trouble caused by a start-bit-detection error can be reduced.

In the above-mentioned embodiment, an example is shown in which the start-bit-level-check circuit 2 is constituted by the latch circuit 2a and the AND circuit 2b and the serial data communication apparatus is constituted by the FF3, the FF4, the reception-clock-pulse-generating circuit 5, the bit counter 6, the decoder 7, and the OR circuit 8. However, the present invention is not limited to this configuration. Therefore, modifications of the construction are possible without departing from the scope of the invention.

What is claimed is:

1. A serial-data-communication apparatus for transmitting and receiving serial data composed of a plurality of bits including a start bit at a head, comprising:
edge-detection means for detecting a trailing edge of received data;
start-bit-level-inspection means for recognizing the reception of the start bit of said received data with the detection of said trailing edge provided by said edge-detection means, and monitoring a bit level of the start bit to examine whether the start bit maintains a predetermined bit level; and
start-bit-detection-error-notification means which outputs a signal to an external circuit, said signal indicating occurrence of an error in detecting the start bit, when any change in the bit level of the start bit is detected by said start-bit-level-inspection means.

2. The serial-data-communication apparatus according to claim 1, wherein said start-bit-detection-error-notification means outputs a signal, indicating occurrence of a start bit detection error, to a CPU, controlling the transmission and reception of the serial data, as an interrupt request signal.

3. A method of detecting a communication error in transmission and reception of serial data composed of a plurality of bits including a start bit at a head, comprising the steps of:
detecting a trailing edge of received data;
recognizing the reception of the start bit of said received data with the detection of said trailing edge, monitoring a bit level of the start bit to examine whether the start bit maintains a predetermined bit level; and
outputting a signal to an external circuit, the signal indicating occurrence of an error in detecting the start bit, when any change in the bit level of the start bit is detected.

4. The method of detecting a communication error according to claim 3, wherein the signal indicating occurrence of the error in detecting the start bit is output to a CPU, controlling the transmission and reception of the serial data, as an interrupt request signal.
